(19) United States
(12) Patent Application Publication
(10) Pub. No.: US 2016/0070330 A1
(43) Pub. Date: Mar. 10, 2016

(54) POWER MANAGING METHOD AND ELECTRONIC SYSTEM APPLYING THE POWER MANAGING METHOD

(71) Applicant: MEDIATEK INC., Taiwan (CN)

(72) Inventors: Jen-Chieh Yang, Hsinchu City (TW); Yong-Sheng Lo, Taichung City (TW); Kai-Hsun Chou, New Taipei City (TW); Kuan-Fu Lin, Taichung City (TW)

(21) Appl. No.: 14/890,164

(22) PCT Filed: Apr. 14, 2015
(86) PCT No.: PCT/CN2015/076525

§ 371 Date: Nov. 10, 2015

Related U.S. Application Data
(60) Provisional application No. 61/981,294, filed on Apr. 18, 2014.

(51) Int. Cl. G06F 1/32

(52) U.S. Cl. CPC G06F 1/3212; G06F 1/3234; G06F 1/3296; G06F 1/324

(57) ABSTRACT

An electronic system (300) comprising: a battery (303); at least one electronic device; and a power managing unit (301), arranged for detecting a battery voltage of the battery (303), and arranged for limiting at least one performance of the at least one electronic device if the battery voltage is not higher than a first low threshold voltage.

### CROSS REFERENCE TO RELATED APPLICATIONS

This application claims the benefit of U.S. Provisional Application No. 61/981,294, filed on Apr. 18, 2014, the contents of which are incorporated herein by reference.

### TECHNICAL FIELD

The present invention relates to a power managing method and an electronic system applying the power managing method, and particularly relates to a power managing method that can avoid the sudden drop for the battery voltage and an electronic system applying the power managing method.

### BACKGROUND

Conventionally, a portable electronic system such as a mobile phone, a laptop or a tablet pc comprises a battery to provide power supply. However, if a battery voltage of the battery suddenly drops due to loading peak, some issues may occur.

FIG. 1 is a schematic diagram illustrating a conventional battery voltage drop issue. As shown in FIG. 1, the battery voltage Vbat may suddenly drop due to peak loading P occurs, which means a total current value of the battery currents provided to the electronic devices in the electronic system is large. For example, the user uses a communication device in the electronic system to transmit data, and simultaneously activates a flash for a camera device of the electronic system. In such case, the electronic system may crush because the battery cannot provide a sufficient battery voltage to the whole electronic system.

Some methods are provided to solve the above-mentioned issue. For example, increase the shutdown threshold voltage, which is a threshold voltage for controlling the electronic system to automatically shut down. If the battery voltage is lower than the shutdown threshold voltage, the electronic system automatically shut down. However, for such method, the effectiveness of the battery is limited. For example, the battery can provide a maximum battery voltage 4V, but the shutdown threshold voltage is 3.0V. That is, the electronic system will shut down if the battery voltage is lower than 3.0 v. In such case, the battery can only support the electronic system to smoothly operate for a short period of time since the shutdown threshold voltage 3.0 v is close to the maximum battery voltage 4V. Alternatively, a more powerful battery which can support a higher battery voltage can be provided to the electronic system to solve above-mentioned issue. However, the cost for the electronic system accordingly increases.

Another method for solving the above-mentioned issue is decreasing total power impedance, which may comprise battery resistance, connector resistance, and PCB (printed circuit board) trace resistance.

FIG. 2 is a schematic diagram illustrating relations between total battery current and the battery voltage. The total battery current means a sum of the battery currents supplied to the electronic devices. The total power impedance lines TR1 and TR2 indicate different total power impedance, and TR2 indicates larger total power impedance than TR1. The total power impedance indicates a sum of battery resistance, connector resistance and circuit board trace resistance.

Also, the battery voltage V1 is larger than the battery voltage V2, and the battery voltage V2 is larger than the battery voltage V3. Additionally, the battery current I11 is larger than the battery current I12, and the battery current I12 is larger than the battery current I13. Further, the battery current I21 is larger than the battery current I22, and the battery current I22 is larger than the battery current I23.

As illustrated in FIG. 2, if the battery voltage is the same, the larger the total power impedance, the smaller the total battery current. For example, if the battery voltage is V3 and the total power impedance line is TR1, the total battery current is 113. If total power impedance line is TR2, the total battery current is I23, which is smaller than 113. Therefore, if the total power impedance is reduced, for example, from the total power impedance line TR2 to the total power impedance line TR1, the battery can provide a larger total battery current while it has the same voltage. Also, the battery can still keep at a higher voltage if the same total battery current is provided. By this way, the above-mentioned issue can be solved. However, it is hard to reduce the total power impedance. Also, if the battery has been used for a long period of time, the battery resistance increases, such that the total power impedance correspondingly raises and makes the above-mentioned issue worse.

### SUMMARY

One objective of the present invention is to provide an electronic system that can avoid the sudden drop for the battery voltage.

Another objective of the present invention is to provide a power managing method that can avoid the sudden drop for the battery voltage.

One embodiment of the present invention discloses an electronic system, which comprises: a battery; at least one electronic device; and a power managing unit, arranged for detecting a battery voltage of the battery, and arranged for limiting at least one performance of the at least one electronic device when the battery voltage is not higher than a first low threshold voltage.

Another embodiment of the present invention discloses an electronic system, which comprises: a battery; at least one electronic device; and a power managing unit, arranged for determining if remaining power of the battery is not higher than a threshold value, and arranged for limiting at least one performance of the at least one electronic device when the remaining power is not higher than a threshold value.

Still another embodiment of the present invention discloses an electronic system, which comprises: a battery; at least two electronic devices; and a power managing unit, arranged for performing: (a) determining if at least two of the electronic devices in a predetermined list will simultaneously operate; and (b) limiting at least one performance of at least one the electronic devices if least two of the electronic devices in the predetermined list will simultaneously operate.

Corresponding power managing methods can be acquired based on above-mentioned embodiments. The steps thereof can be easily understood according to above-mentioned embodiments, thus are omitted for brevity here.

In view of above-mentioned embodiments, a peak for the total battery current can be avoided since a total battery current provided to electronic devices can be well controlled. By this way, the sudden drop issue for the battery voltage can be improved.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram illustrating a conventional battery voltage drop issue.

FIG. 2 is a schematic diagram illustrating relations between a total battery current and a battery voltage.

FIG. 3 is a block diagram illustrating an electronic system according to one embodiment of the present invention.

FIG. 4 and FIG. 5 are schematic diagrams illustrating the operation for the electronic system depicted in FIG. 3, according to one embodiment of the present invention.

FIG. 6 is a flow chart illustrating the operation for the electronic system depicted in FIG. 3, according to one embodiment of the present invention.

FIG. 7 and FIG. 8 are flow charts illustrating power managing methods according to other embodiments of the present invention.

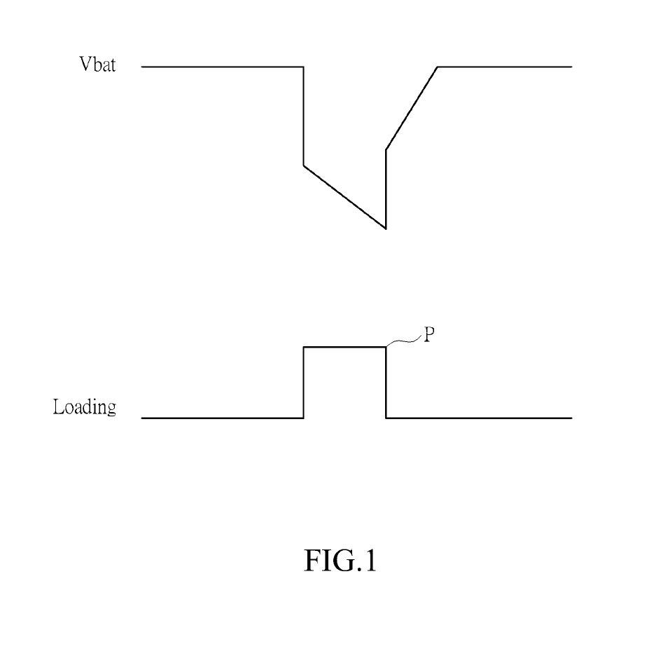

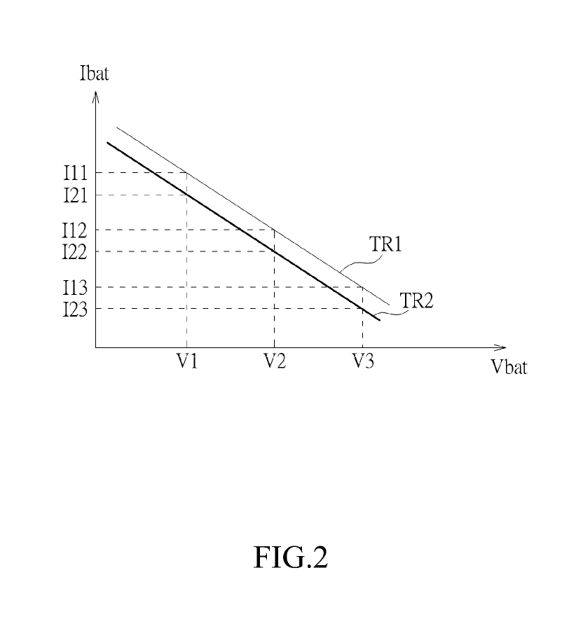

### DETAILED DESCRIPTION

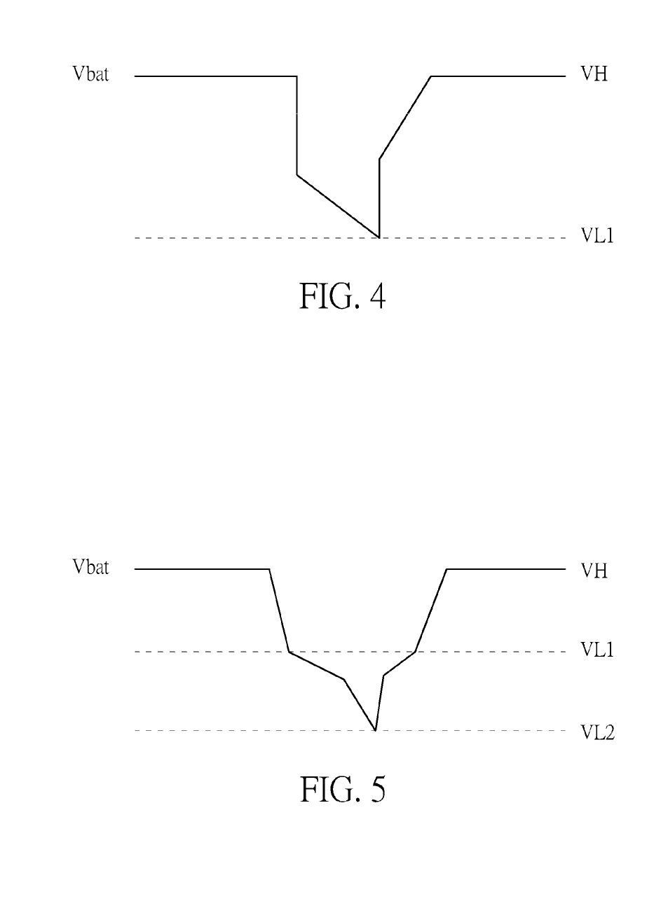

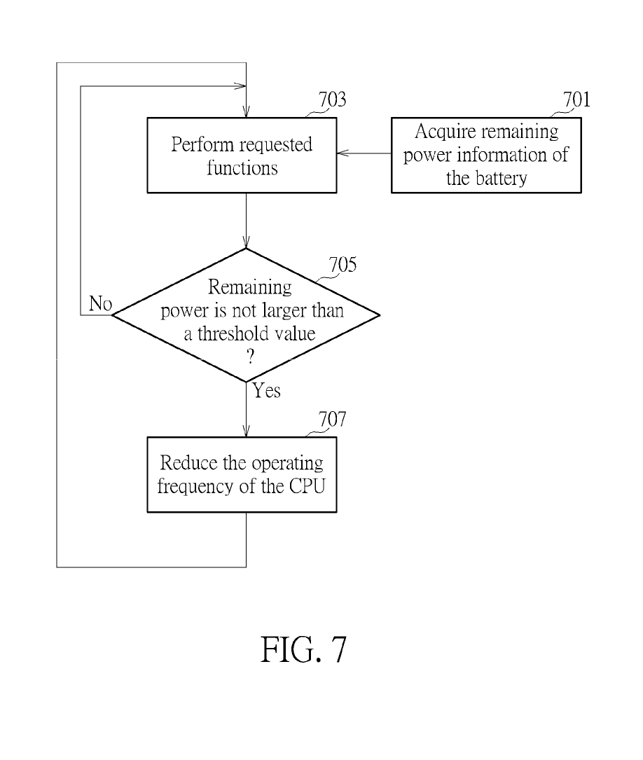

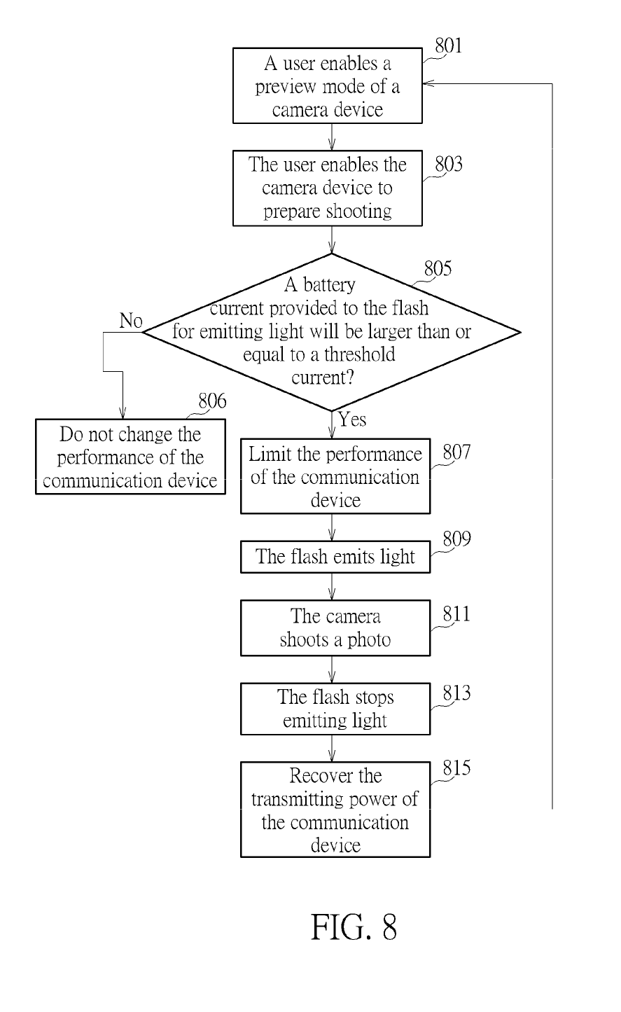

A power managing mechanism provided by the present invention will be described below. The power managing mechanism comprises a passive mode depicted in FIG. 4-FIG. 6, and an active mode depicted in FIG. 7, FIG. 8. The passive mode and the active mode can be applied simultaneously or independently.

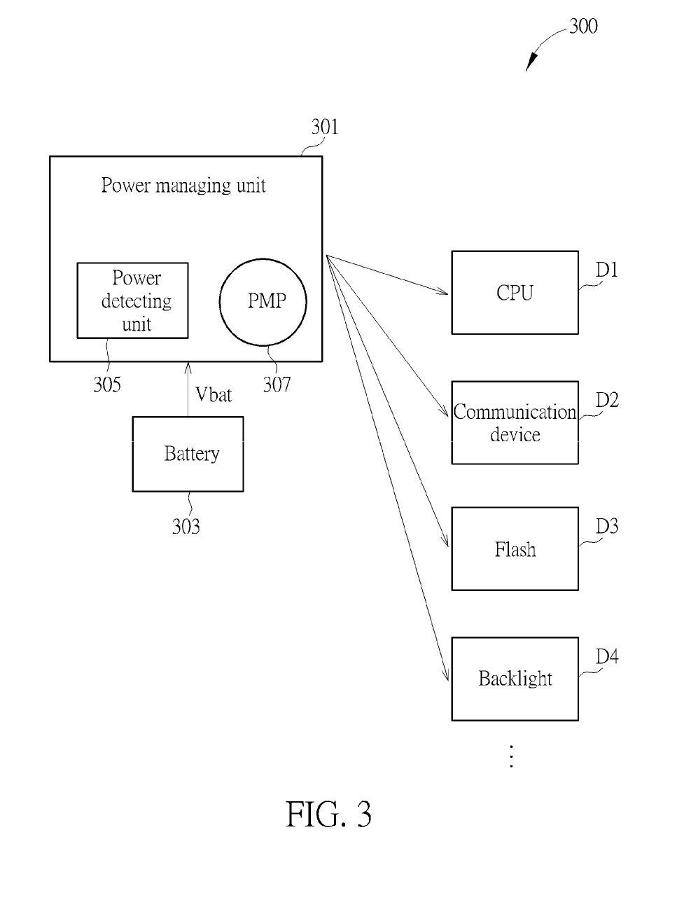

FIG. 3 is a block diagram illustrating an electronic system according to one embodiment of the present invention. FIG. 4 and FIG. 5 are schematic diagrams illustrating the operation for the electronic system depicted in FIG. 3, according to one embodiment of the present invention. Please simultaneously refer to the FIG. 3/FIG. 4, or FIG. 3/FIG. 5, to understand the concept for the present invention for more clear.

As illustrated in FIG. 3, the electronic system 300 comprises a power managing unit 301, a battery 303, and a plurality of electronic devices D1, D2, D3, and D4. The power managing unit 301 detects a battery voltage Vbat of the battery 303. If the battery voltage Vbat is not higher than a first low threshold voltage VL1(as illustrated in FIG. 4), the power managing unit 301 limits at least one performance of the electronic device D1, D2, D3, D4. In one embodiment, if the battery voltage Vbat is higher than the first low threshold voltage VL1, the power managing unit 301 does not limit the performance of the electronic device D1, D2, D3, D4.

In one embodiment, if the performance of the electronic device is already limited as depicted in the description of FIG. 4, the power managing unit 301 further detects if the battery voltage Vbat rises back to a high threshold voltage VH higher than the first low threshold voltage VL1 (as illustrated in FIG. 4), and releases the limiting for the performance of the electronic device if the battery voltage rises back to be higher than or equal to (not lower) the high threshold voltage VH.

In another embodiment, if the performance of the electronic device is limited, the power managing unit 301 detects if the battery voltage falls down to a second low threshold value VL2 (as illustrated in FIG. 5) lower than the first low threshold value (VL1). If the battery voltage falls down to be lower than or equal to (not higher) the second low threshold value VL2, the power managing unit 301 limits at least one performance of the electronic device to a level lower than a level of the embodiment depicted in FIG. 4. By this way, a total battery current smaller than which in FIG. 4 is provided.

In one embodiment, the power managing unit 301 reduces at least one following parameter of the electronic device D1, D2, D3, D4 to limit the performance of the electronic device D1, D2, D3, and D4: an operating voltage, an operating frequency, a battery current and a data transmitting power. In such embodiment, the above-mentioned operation “to a level lower than a level of the embodiment” depicted in FIG. 4 means providing a lower operating voltage, a lower operating frequency, a lower battery current and a lower data transmitting power to the electronic device.

Additionally, in one embodiment, the power managing unit 301 comprises a power detecting unit 305 for detecting the battery voltage Vbat, and executes a power managing program 307 to control the performances of the electronic devices, but not limited. Also, in one embodiment, the electronic device D1 is a CPU (central processing unit), the electronic device D2 is a communication device such as a modem or a Bluetooth device, the electronic device is a flash for a camera device, and the electronic device D4 is a backlight. However, the scope of the present invention is not limited to these embodiments.

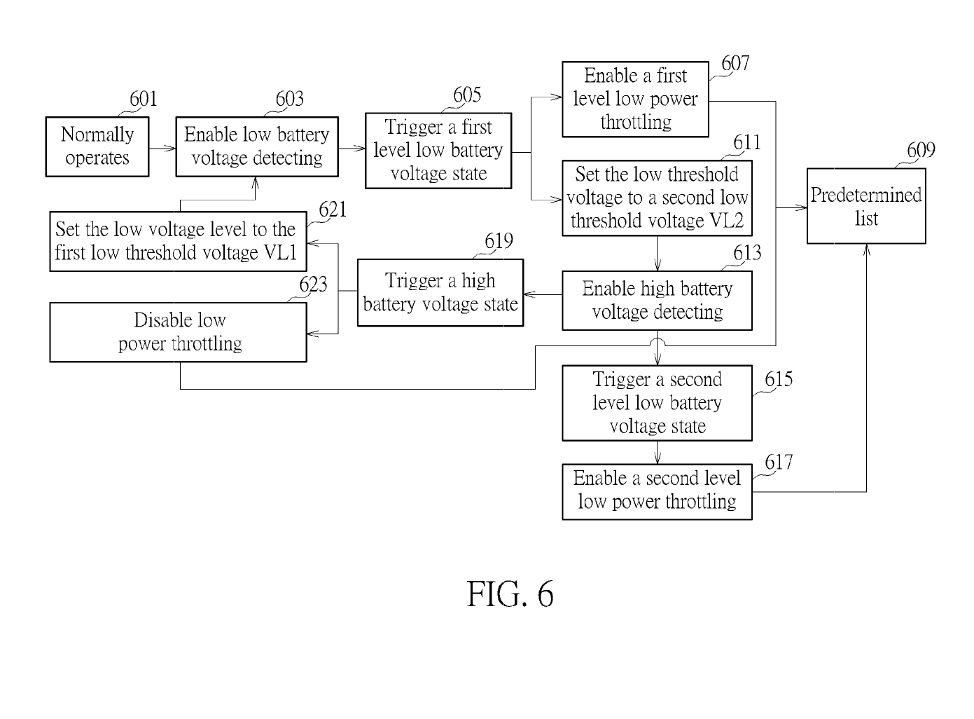

FIG. 6 is a flow chart illustrating the operation for the electronic system depicted in FIG. 3, according to one embodiment of the present invention. The flow chart in FIG. 6 comprises:

Step 601

The electronic system normally operates. That is, the electronic system operates based on default settings.

Step 603

Enable low battery voltage detecting. That is, start to determine if the battery voltage is not higher than a low threshold voltage. In such case, the low threshold voltage is a first low threshold voltage VL1 (3.25 v in this example), which is set by the step 621.

Step 605

Trigger a first level low battery voltage state if the battery voltage Vbat is not higher than the first low threshold voltage VL1.

Step 607

Enable a first level low power throttling. That is, limit at least one performance of the electronic device for a first level.

Step 609

Limit the performance for the electronic devices listed in a predetermined list. In one embodiment, the predetermined list lists the electronic devices consuming a large battery current, for example, a CPU, a GPU (graphic processing unit), a flash (ex. for a camera device), a communication device, or a panel.

Step 611

Set the low threshold voltage to a second low threshold voltage VL2 (3.0 v in this example).

Step 613

Enable high battery voltage detecting. That is, start to determine if the battery voltage rises to be higher than or equal to a high threshold voltage VH. Please note the battery voltage is also detected to determine if the battery voltage falls down to be lower than or equal to the low threshold voltage, which is now the second low threshold voltage VL2.

If the battery voltage rises to be higher than or equal to (i.e. not lower) than a high threshold voltage VH, then go to the step 619. On the opposite, if the battery voltage falls down to be lower than or equal to (i.e. not higher) than the second low threshold voltage VL2, then go to the step 615.

Step 615

Trigger a second level low battery voltage state if the battery voltage Vbat is not higher than the second low threshold voltage VL2.

Step 617

Enable a second level low power throttling. That is, limit at least one performance of the electronic device for a second level. The second level is higher than the first level of the step 605. In other words, the performances of the electronic devices are limited more strictly in the step 617 than in the step 607. After the step 617, goes to the step 609.

Step 619

Trigger a high battery voltage state. That is, the battery voltage Vbat is not lower than the high threshold voltage VH.

Step 621

Set the low voltage level to the first low threshold voltage VL1 (3.25 v in this example).

Step 623

Disable low power throttling. That is, do not limit the performances for the electronic devices.

A power managing method according to above-mentioned embodiments can be summarized as: a power managing method, applied to an electronic system comprising a battery and at least one electronic device, comprising: (a) detecting a battery voltage of the battery; and (b) limiting at least one performance of the at least one electronic device when the battery voltage is not higher than a first low threshold voltage. Other detail steps can be acquired according to above-mentioned embodiments, thus are omitted for brevity here.

Embodiments for the active mode will be described as below . . . FIG. 7 and FIG. 8 are flow charts illustrating power managing methods according to other embodiments of the present invention. The methods depicted in FIG., 7 and FIG. 8 can be performed by the power managing unit in FIG. 3 as well. The embodiment in FIG. 7 comprises the following steps:

Step 701

Acquire remaining power information of the battery.

Step 703

Electronic devices perform requested functions. For example, if the electronic device is a CPU, the electronic device process requested tasks.

Step 705

Determine if remaining power of the battery is lower than or equal to (i.e. not higher) a threshold value (ex. 15% of the full battery power). If yes, go to step 707. If not, do not change the operating frequency of the CPU and goes back to the step 703.

Step 707

Reduce the operating frequency of the CPU.

Please note the steps depicted in FIG.7 are not limited to be applied to a CPU, and can be applied to other electronic devices as well. Accordingly, an power managing method based on the embodiment of FIG. 7 can be summarized as: A power managing method, applied to an electronic system comprising a battery and at least one electronic device, comprising: (a) determining if remaining power of the battery is not higher than a threshold value (ex. based on remaining power information acquired in the step 701); and (b) limiting at least one performance of the at least one electronic device when the remaining power is not higher than a threshold value(ex. the steps 705, 707).

The following parameters can be reduced to limit at least one performance of the at least one electronic device: an operating voltage, an operating frequency, a battery current and a data transmitting power.

The embodiment in FIG. 8 discloses an embodiment which limiting at least one performance for one of the electronic devices while at least two the electronic devices simultaneously operate. In this embodiment, one electronic device is a flash of a camera device, and the other electronic is a communication device. Also, the communication device is requested to transmit data while the flash is ready to operate. FIG. 8 comprises the following steps:

Step 801

A user enables a preview mode of a camera device. For example, a mobile phone comprises a camera device, and the user activates the camera, uses the screen for the mobile phone to preview a photo that the camera will shot.

Step 803

The user enables the camera device to prepare shooting. For example, the user touches the screen to focus on an object that will be shot by the camera device. A flash, such as an LED (light emitting diode) included in the mobile phone, may also emit light if a photo is shot.

Step 805

Determine if a battery current provided to the flash for emitting light will be larger than or equal to (i.e. not smaller) than a threshold current. If yes, go to step 807. If not, go to step 806.

Step 806

Do not change the performance of the communication device.

Step 807

Limit the performance of the communication device. In one embodiment, reduce the data transmitting power of the communication device to limit the performance of the communication device.

Step 809

The flash emits light.

Step 811

The camera shoots a photo.

Step 813

The flash stops emitting light.

Step 815

Recover the transmitting power of the communication device.

For the embodiment depicted in FIG. 8, the flash and the communication device are all devices listed in a predetermined list, which means the electronic device will consume a large battery current. If such devices simultaneously operate, the battery voltage may significantly drop. Accordingly, the transmitting power of the communication device is reduced when the flash is ready for operating (steps 807, 809, 811).

Please note the embodiment in FIG. 8 is not limited to be applied to a flash and a communication device. Accordingly, the embodiment depicted in FIG. 8 can be summarized as: a power managing method, applied to an electronic system comprising a battery and at least one electronic device, comprising: (a) determining if at least two of the electronic device in a predetermined list will simultaneously operate; and (b) if yes, limit at least one performance of the at least one electronic device. In one embodiment, if the step(a) determines a first electronic device in the predetermined list is ready for operating (ex. the flash) and a second electronic device does not operate yet(ex. the communication device), the step (b) limits the performance of the second electronic device. Furthermore, in one embodiment, such power managing method is performed if the battery voltage is not higher than a low threshold voltage.

In view of above-mentioned embodiments, a peak for the total battery current can be avoided since a total battery current provided to electronic devices can be well controlled. By this way, the sudden drop issue for the battery voltage can be improved.

Those skilled in the art will readily observe that numerous modifications and alterations of the device and method may be made while retaining the teachings of the invention. Accordingly, the above disclosure should be construed as limited only by the metes and bounds of the appended claims.

1. A power managing method, applied to an electronic system comprising a battery and at least one electronic device, comprising:
(a) detecting a battery voltage of the battery; and
(b) limiting performance of the at least one electronic device when the battery voltage is not higher than a first low threshold voltage.

2. The power managing method of claim 1, further comprising:
providing a high threshold voltage higher than the first low threshold voltage, and releasing the limit for the performance of the at least one electronic device when the battery voltage rises to the high threshold voltage.

3. The power managing method of claim 1, wherein the step (b) reduces at least one following parameter of the at least one electronic device to a first level, to limit the performance of the at least one electronic device: an operating voltage, an operating frequency, a battery current and a data transmitting power.

4. The power managing method of claim 3, further comprising:
providing a second low threshold value lower than the first low threshold value;
and
reducing at least one following parameter of the at least one electronic device to a second level lower than the first level when the battery voltage falls down to the second low threshold value, to limit the performance of the at least one electronic device: the operating voltage, the operating frequency, the battery current and the data transmitting power,

5. A power managing method, applied to an electronic system comprising a battery and at least one electronic device, comprising:
(a) determining if remaining power of the battery is not higher than a threshold value; and
(b) limiting at least one performance of the at least one electronic device when the remaining power is not higher than a threshold value.

6. The power managing method of claim 5, wherein the step (b) reduces at least one following parameter of the at least one electronic device to limit the performance of the at least one electronic device: an operating voltage, an operating frequency, a battery current and a data transmitting power.

7. A power managing method, applied to an electronic system comprising a battery and at least two electronic devices, comprising:
(a) determining if at least two of the electronic devices in a predetermined list will simultaneously operate; and
(b) limiting at least one performance of t at least one of the electronic devices when at least two of the electronic devices in the predetermined list will simultaneously operate.

8. The power managing method of claim 7, wherein the step (b) limits the performance of a second electronic device when the step (a) determines a first electronic device in the predetermined list is ready for operating and the second electronic device in the predetermined list does not operate yet.

9. The power managing method of claim 8, wherein the first electronic device is a communication device and the second electronic device is a flash.

10. The power managing method of claim 8, further comprising determining a battery current that will be supplied to the first electronic device, wherein the step (b) limits the performance of the second electronic device when the battery current that will be supplied to the first electronic device is not smaller than a threshold current.

11. The power managing method of claim 7, further comprising:
detecting a battery voltage of the battery, and performing the step (a) and (b) when the battery voltage is not higher than a low threshold voltage.

12. An electronic system, comprising:
a battery;
at least one electronic device; and
a power managing unit, arranged for detecting a battery voltage of the battery, and arranged for limiting at least one performance of the at least one electronic device when the battery voltage is not higher than a first low threshold voltage.

13. The electronic system of claim 12, wherein the power managing unit detects whether the battery voltage rises to a high threshold voltage higher than the first low threshold voltage or not, and releases the limit for the performance of the at least one electronic device when the battery voltage rises to the high threshold voltage.

14. The electronic system of claim 12, wherein the power managing unit reduces at least one following parameter of the at least one electronic device to a first level, to limit the performance of the at least one electronic device: an operating voltage, an operating frequency, a battery current and a data transmitting power.

15. The electronic system of claim 12, wherein the power managing unit detects whether the battery voltage falls down to a second low threshold value lower than the first low threshold value or not, wherein the power managing unit limits at least one performance of the at least one electronic device to a second level lower than the first level, when the battery voltage falls down to the second low threshold value.

16. An electronic system, comprising:
a battery;
at least one electronic device; and
a power managing unit, arranged for determining if remaining power of the battery is not higher than a threshold value, and arranged for limiting at least one performance of the at least one electronic device when the remaining power is not higher than a threshold value.

17. The electronic system of claim 16, wherein the power managing unit reduces at least one following parameter of the at least one electronic device to limit the performance of the at least one electronic device: an operating voltage, an operating frequency, a battery current and a data transmitting power.

18. An electronic system, comprising:
a battery;
at least two electronic devices; and
a power managing unit, arranged for performing:
(a) determining if at least two of the electronic devices in a predetermined list will simultaneously operate; and
(b) limiting at least one performance of at least one the electronic devices if least two of the electronic devices in the predetermined list will simultaneously operate.

19. The electronic system of claim 18, wherein the power managing unit limits the performance of a second electronic device when the power managing unit determines a first electronic device in the predetermined list is ready for operating and the second electronic device in the predetermined list does not operate yet.

20. The electronic system of claim 19, wherein in the first electronic device is a communication device and the second electronic device is a flash.

21. The electronic system of claim 19, wherein the power managing unit determines a battery current that will be supplied to the first electronic device, wherein the power managing unit limits the performance of the second electronic device when the battery current that will be supplied to the first electronic device is not smaller than a threshold current.

22. The electronic system of claim 18, wherein the power managing unit detects a battery voltage of the battery, and performs the steps (a) and (b) when the battery voltage is not higher than a low threshold voltage.
